(19) United States
(12) Patent Application Publication
(10) Pub. No.: US 2013/0152632 A1
(43) Pub. Date: Jun. 20, 2013

(54) METHOD AND DEVICE FOR MANUFACTURING VITREOUS SLAG

(71) Applicants: Romain Frieden, McMurray, PA (US); Bill Ebner, Canonsburg, PA (US); Tom Schorr, Allison Park, PA (US); Scott Duncan, Canonsburg, PA (US); George Paul, Washington, PA (US); Horst Kappes, Trier (DE)

(72) Inventors: Romain Frieden, McMurray, PA (US); Bill Ebner, Canonsburg, PA (US); Tom Schorr, Allison Park, PA (US); Scott Duncan, Canonsburg, PA (US); George Paul, Washington, PA (US); Horst Kappes, Trier (DE)

(73) Assignee: PAUL WURTH S.A., Luxembourg (LU)

(21) Appl. No.: 13/699,995

(22) PCT Filed: May 25, 2011
(86) PCT No.: PCT/EP2011/058581

§ 371 Date: Nov. 26, 2012

(30) Foreign Application Priority Data
May 26, 2010 (LU) 91 692
Sep. 13, 2010 (LU) 91 728

(51) Int. Cl. C04B 5/00

(52) U.S. Cl. CPC C04B 5/00
USPC 65/19; 65/258; 65/181

(57) ABSTRACT

A process for manufacturing a vitreous slag including
rotating a cone about a vertical cone axis, the cone including an external shell having a lateral surface;
cooling the lateral surface of the external shell;
pouring molten slag onto the lateral surface of the cone to form a film of slag by gravity, which is solidified as it is entrained in rotation by the cone about the cone axis; and
   detaching pieces of the film from the lateral surface and removing solidified slag in the form of the pieces after the film has been entrained through between 0.6 and 0.9 revolutions of the cone, the molten slag being poured onto the lateral surface in a pouring zone and spreads to form a film over substantially the entire length of the lateral surface, preferably over between 75% and 95% of the length of the lateral surface.

### TECHNICAL FIELD

The present invention generally relates to dry solidification of slag from the metal industry and more particularly from the iron industry, in particular in combination with a heat recovery.

### BRIEF DESCRIPTION OF RELATED ART

Molten slag at high temperature is usually produced in the smelting of ores and in the fining or refining of raw metal. The tapping of the slag removes heat from the system at a high rate and the liquid slag is cooled and assumes a solid state in a relatively short time and can then be handled, although with some difficulty.

In general, the slag has limited economic value. Only a small part of the slag is used as a building material and a major part may have to be dumped as a waste material, although it contains substantial thermal energy, and is lost for the recovery of the heat that has been removed from the system.

As the recognition of minimizing waste and of the need to save energy has increased, numerous efforts have been made to direct more attention to molten waste slag.

Japanese Patent 61-08 357 B (C.A. Vol. 105, Ref. 9845 y) discloses, for the granulating of slag, an apparatus that consists of a compact drum. Water-cooled wings are attached to a central shaft and are reversibly rotated to divide the slag. The bottom half of the drum is cooled by flowing water, and the water, which has been heated, is delivered to a plant for a recovery of energy. The drum has a lateral inlet and an outlet for discharging the granulated slag.

GB 2002 820 describes an apparatus for granulation of molten which comprises a rotating conical or frusto-conical target against which jets of molten slag are projected at high velocity from nozzles.

The jets of molten slag disintegrate upon impact on the target and the slag bounces off the target surface in the form small granules, which are projected in a fluidized bed and cooled. The outer surface of the target is hard, smooth and heat resistant and heat conducting. The target has an apex angle of about 60° to 80.

SU 1 101 432 A1 describes an apparatus for cooling of liquid slag on the inner surface of a fixed, inverted, hollow cone. On the upper part of the cooling surface of the inverted cone, a lid is arranged on supports covering the cooling surface from the top and setting it in a rotational motion around an axis coinciding with the vertical axis of the cooling surface by a drive. On a movable lid, a channel for feeding the slag and a device for crushing the slag are arranged. To facilitate the transport of the molten slag to the apparatus, the channel for feeding the slag consist of a receiving vessel, the axis of which coincides with the rotational axis of the moveable lid, a distributing vessel arranged at the periphery of the movable lid and a chute connecting the two vessels. During rotation of the movable lid, the distributing vessel moves along the upper edge of the cooling surface. The device for crushing the slag is formed as a hammer mill with swinging hammers and has a separate drive.

U.S. Pat. No. 4,909,837 discloses a process and apparatus for granulating slag, in which molten slag is charged into a drum and is solidified and granulated therein on cooled surfaces. To ensure a rapid cooling at a high throughput rate, the molten slag is applied to the inside surface of a drum, which rotates on a horizontal axis and has a cooled shell, and the solidified film of slag is mechanically detached from the inside surface after about three-quarters of a revolution of the drum.

U.S. Pat. No. 4,050,884 describes a process for absorbing the heat from the cooling and solidification of metallurgical slags and converting of said heat into a useful form of energy such as steam.

In U.S. Pat. No. 4,330,264 an apparatus for manufacturing a vitreous slag is described, which comprises: a pair of cooling drums, the peripheral surfaces of said pair of cooling drums being in contact with each other, and said pair of cooling drums rotating in directions opposite to each other at the same peripheral speed; a pair of weirs provided at the upper halves of the both ends of said pair of cooling drums so as to be in contact with said both ends of said pair of cooling drums, a slag sump being formed by means of said pair of weirs and the bodies of said pair of cooling drums, and molten slag being poured into said slag sump; a cooling medium for cooling said pair of cooling drums, said cooling medium comprising a high boiling point heat medium having a boiling point of at least 200° C. under atmospheric pressure, said high boiling point heat medium being fed into each of said pair of cooling drums, exchanging heat with said molten slag in said slag sump, deposited onto the peripheral surfaces of said pair of cooling drums, and being discharged from each of said pair of cooling drums under a pressure of up to 5 kg/cm² for heat recovery, whereby said molten slag is substantially completely converted into a vitreous slag through heat exchange with said high boiling point heat medium, and is peeled off from the peripheral surfaces of said pair of cooling drums by a scraper.

The known processes do not always satisfy the requirements or commercial practice and also, have the disadvantage that they can be performed only with difficulty in practice.

### BRIEF SUMMARY

The invention provides a process and an apparatus for dry slag solidification that do not present the above-mentioned disadvantage.

This is accomplished in accordance with the invention by a process for manufacturing a vitreous slag that comprises the steps of:
rotating a cone about a vertical cone axis, said cone comprising an external shell having a lateral surface;
cooling the lateral surface of said external shell;
pouring molten slag onto said lateral surface of said cone to form a film of slag by gravity, which is solidified as it is entrained in rotation by said cone about said cone axis; and
detaching pieces of said film from said lateral surface and removing solidified slag in the form of said pieces after said film has been entrained through between 0.6 and 0.9 revolutions of said cone,
   said molten slag being poured onto said lateral surface in a pouring zone and spreads to form a film over substantially the entire length of said lateral surface, preferably over between 75% and 95% of the length of said lateral surface.

Molten slag is thus applied to the outside or exterior lateral surface of a cone rotating on a vertical axis and having a cooled shell and so as to form a solidified film of vitreous slag. The solidified film of vitreous slag is mechanically detached from the outside surface preferably after about 75% to 95% of a revolution of the cone and is discharged.

In the process according to the invention, the molten slag is continuously or discontinuously poured onto the inclined lateral surface adjacent to the top of the cone, preferably in the upper half thereof, more preferably in the upper third thereof, and spreads through the action of gravity and rotation substantially over the entire height of the cooled shell of the cone.

It is important to note that the liquid slag is poured i.e. dispensed onto the lateral surface of the cone so as to avoid that the slag flow bounces back in the air and disintegrates into granules. The slag is thus poured onto the cone from a minimal height corresponding to thickness of the wall of the pouring trough plus a safety margin so as to avoid that the pouring trough comes into contact with the rotating cone. The height is preferably between 100 and 600 mm, more preferably between 200 and 400 mm. The impact velocity of the slag is thus kept low, preferably well below 1 m/s.

Optionally, one or more rollers may be used to assist the spreading of the slag on the lateral surface of the cone and to control the thickness of the slag film. The one or more rollers may be cooled to remove heat from the slag. Preferably, however, the spreading of the slag on the lateral surface of the cone is achieved without such rollers, only under the action of gravity and rotation.

An advantage of the present process is that the formation of a uniform film is achieved by the combined action of gravity and rotation so that it can be performed without difficulty in practice. The liquid slag runs down the cooled lateral surface of the cone and forms a solidified skin after coming in contact with the cooled surface.

The further the liquid slag advances on its way toward the bottom of the cone, the more slag is solidified and upon reaching the lower end of the surface, the film is entirely solidified. The molten slag runs down the lateral surface of the cone like a lava stream running down the slopes of a volcano. Through the rotation of the cone, the slag comes constantly in contact with a fresh cooled surface and it is thus made sure that no liquid slag runs over the lower edge of the cone.

The slag is thus distributed evenly over the surface of the cooling cone by the combined action of gravity and rotation even though it is dropped at one comparatively small pouring zone on the surface, near the top of the cone, without the need of a spreading device or reservoir. This is a considerable advantage over the above cited prior art slag solidification devices wherein the slag is distributed onto the cooling surface via a reservoir and/or via more or less complicated spreading devices. The disadvantage of these prior art devices is that the slag sooner or later solidifies and blocs these devices by forming crusts and thus jeopardizing the even distribution of the liquid slag and thus necessitating frequent stand stills for repair.

In the process according to the invention, the liquid slag does not necessarily have to be fed over the entire length of a surface as described for example in U.S. Pat. No. 4,909,837. In practice, it is indeed very difficult to achieve the formation of uniform film over a length by tilting a pouring trough filled with liquid slag because the slag has a tendency to form crusts inside the trough and after a while it becomes impossible to pour the liquid slag uniformly over the length of the trough. Furthermore, no device such as a scraper described in LU 87677 needs to be used to insure that a film of uniform thickness is achieved. Such scraper devices present the disadvantage that slag solidifies relatively quickly around the edges of the scraper and the film of slag to be formed becomes irregular. The solidification needs to be interrupted and the scraper must be freed from the solidified slag before the solidification can be continued.

As opposed to the prior art, the thickness of the film or the length of the film over the lateral surface i.e. the distance the liquid slag flows from the pouring zone down the lateral surface until it is completely solidified and stops flowing can be adjusted and be kept within an acceptable range simply by varying the rotational speed of the cone.

The rotational speed of the cone is preferably set so as to form a film of slag on the entire length of the lateral surface of the cone i.e. between the pouring zone and the lower edge of the cone of a thickness of 5 to 10 mm. The thickness adjusts itself depending upon the temperature of the slag. Preferably, the angular velocity of the cone is regulated in relationship to the measured film thickness. If the temperature is low the slag layer will be thicker and the cone will have to turn slower. At higher temperature, the slag layer will be thinner and the speed faster.

A further advantage afforded by the process of solidifying slag in accordance with the invention, is that the rotation of the cone continually makes fresh cooling surfaces available for cooling the molten slag and ideal conditions are ensured for the solidification and vitrification of the slag. It can be made sure to always obtain a film of substantially entirely vitrified slag independent of the initial temperature and viscosity of the slag simply by adjusting the rotational speed of the cone.

As used in the present invention, the term “cone” refers to a three-dimensional geometric shape that tapers smoothly from a flat, usually circular base to a point called the apex or vertex. More precisely, it is the solid figure bounded by a plane base and the surface (called the lateral surface) formed by the locus of all straight line segments joining the apex to the perimeter of the base. The axis of a cone is the straight line, passing through the apex, about which the lateral surface has a rotational symmetry.

The cone used in the present invention is preferably a right circular cone, where right means that the axis passes through the center of the base at right angles to its plane, and circular means that the base is a circle. It is preferably a so-called truncated cone, i.e. cut off below or above the apex.

The slag can be poured from a slag bucket suspended in a pouring device and/or through a pouring trough, which ends adjacent to the top of the cone. The slag can be poured directly from a slag runner system of a metal producing furnace, with the slag runner system being extended to a point adjacent to the top of the cone. This would be almost impossible for the fixed cone and rotating feed of the Russian patent SU 1 101 432 A1.

The thickness of the film formed on the surface of the cone depends on the viscosity of the slag, the angle α between the base and the surface of the cone, the mass flow or flow rate of the slag and the rotational speed of the cone. In practice, the thickness of the film is thus influenced by the rotational speed of the cone. Higher rotational speeds of the cone or an increased angle α generally result in thinner films of slag.

When the film of slag has moved through about three-fourths of a revolution of the cone, it is detached in the form of lumps or pieces by a detaching device. Such a detaching or peeling device may comprise a scraper or a rapping device or both, or a similar device. It is mounted along the height of substantially the entire surface of the cone. The rapping device can comprise a hammer station and/or a knurled face roller, which suitably precedes a scraper in the direction of rotation of the cone.

The slag is preferably at a temperature of about 1200 to 1600° C. as it is charged onto the cone and is preferably discharged from the cone as the solidified film of vitreous slag reaches about 600° C. to 900° C. The film is typically detached in the form of irregularly shaped lumps or plate-like pieces having a thickness of about 5 to 10 mm and length and width dimensions of up to about 100 mm. The larger pieces of solidified slag may break as they drop from the cone, e.g. into a chute. The length and the width of the slag pieces may depend on and thus be adjusted with the configuration of the rapping device and/or the scraper.

The detached slag pieces or small slag lumps are preferably collected below the scraper in a suitable device and are discharged from the cone by that device, which suitably comprises a slag-collecting chute situated below the cone. The detached slag pieces or small slag lumps may then be transferred with an insulated conveyor belt, a vibratory conveying trough or the like, e.g. to a slag crusher.

After being crushed in the slag crusher, the slag may be further cooled in a heat exchanger and the recuperated heat is preferably used to generate steam and/or electricity. In practice, cold air is blown through the bottom of a silo containing the crushed slag, heated up in contact of the crushed slag, and recuperated at the top of said silo. The heated air is then transferred to a boiler to generate steam and/or electricity. It has to be noted that the heat recuperated during the solidification can also be used to generate steam and/or electricity.

According to another aspect, the invention concerns a device for manufacturing a vitreous slag, which comprises:
a cone having a substantially vertical cone axis and a shell,
said shell having first and a second side, said second side being opposite of said first side;
a drive for rotating said cone, said drive being adapted to rotate said cone around its cone axis;
a slag feeder, arranged in proximity of the shell for pouring a molten slag in a pouring zone onto said first side of said shell;
a detaching device to remove the slag film from the shell;
a cooling device for cooling said shell,
   wherein said device is configured to convert molten slag deposited onto said shell into a vitreous slag film.

The detached slag pieces or small slag lumps are collected below the scraper in a suitable device and are discharged from the cone by that device, which suitably comprises in a slag-collecting chute situated underneath the cone. The detached slag pieces or small slag lumps are then transferred to an insulated conveyor belts, a vibratory conveying trough or the like, possibly to a slag crusher, and to a heat exchanger.

The device for manufacturing a vitreous slag may comprise one or more rollers arranged facing the cone shell to assist the spreading of the slag on the cone shell and to control the thickness of the slag film. The one or more rollers may be cooled to remove heat from the slag.

The device for manufacturing vitreous slag is preferably part of an installation for recuperating heat from the slag. That installation preferably comprises a heat exchanger arranged to receive the solidified slag from the vitreous slag manufacturing device (possibly after crushing of the slag pieces in the slag crusher). The heat exchanger is configured for further cooling the solidified slag and to make the thermal energy of the slag available for further use, e.g. to generate steam and/or electricity using the recuperated heat. The heat exchanger may be configured as a silo, which may be filled with the hot solidified slag and through which air may be blown from the bottom to the top. The air is heated up in contact of the solidified slag, and recuperated at the top of the silo. The heated air is then preferably transferred to a boiler to generate steam and/or electricity. It has to be noted that the heat recuperated during the solidification of the slag on the cone can also be used to generate steam and/or electricity.

The device for manufacturing a vitreous slag comprises in a preferred embodiment a conical slag solidification device, which is provided with cooler and a drive/gear to rotate the cone around its axis. The drive/gear is preferably designed to rotate the cone at about 0.5 to 5 rpm. The base of the cone in accordance with a preferred embodiment of the invention may be about 2 to 30 m in diameter. The shell of the cone may have a length of about 1 to 10 m, measured from the pouring zone to the base. The angle α between the base and the lateral surface is advantageously comprised between 10 and 35 degrees. These dimensions depend of course on the expected throughput of molten slag, which has to be treated. The above cited dimensions can accommodate a throughput of about 6 t/min (tons per minute) of slag at about 1300° C. Should smaller or larger throughputs be used, those skilled in the art can easily adapt the dimensions of the solidification device accordingly.

The cooling medium, after having been heated during the slag solidification can be delivered to a plant for the recovery of heat. In addition, smoke and fumes formed during the pouring operation can be entirely removed in a simple manner.

The device for manufacturing a vitreous slag in accordance with the invention, is preferably provided with means for cooling the shell of the cone. This cooling means may comprise an internally cooled shell. The cooling means may comprise a water (or other heat transfer medium) passage, keeping the water or other heat transfer medium from exposure to the air and dirt of the industrial environment. The heat transfer medium passage on the rotary cone is preferably connected to a stationary part of the coolant circuit via a rotary union connection. The cooling means may further comprise spray nozzles provided on the second i.e. the opposite side of the shell onto which the liquid slag is poured at least in the region in which the liquid slag is poured. It is understood that the spray nozzles spray the cooling medium, preferably water, on the “backside” of the shell i.e. on the opposite side of the surface on which the slag is poured. Thus it is ascertained that the cooling medium does not get into direct contact with the slag.

Additional nozzles can be suitably arranged around part or all of the shell of the cone on the side opposite of the side of the shell were the liquid slag is poured. As a result, cooling water will flow in contact with virtually the entire second side of the shell of the rotating cone. The cooling medium that has been heated may be collected in a tub below the cone and may be delivered to a plant for a recovery of heat. The additional nozzles may be configured to operate only in case of emergency, e.g. if the flow rate of slag exceeds the design parameter of the cone and heat evacuation through the coolant circuit becomes insufficient.

According to a further preferred embodiment, the detached pieces of said slag film are crushed to form slag particles, which are charged in a heat exchanger, cooled with a countercurrent flow of cooling gas and discharged from the heat exchanger. The heat exchanger is subdivided in a plurality of subunits, each of said subunits having a slag particles inlet port, a slag particles outlet port, a cooling gas inlet port and a cooling gas outlet port, wherein at least one of the subunits is charged with hot slag particles through the inlet port, cooled slag particles are discharged through said slag particles outlet port from said at least one of the subunits, said cooling gas inlet port and said cooling gas outlet port being closed during the charging and discharging of slag particles and wherein, simultaneously to the charging and discharging of slag particles, at least one of the other subunits is cooled by injecting a flow of cooling gas through the cooling gas inlet port and withdrawing a flow of heated cooling gas from said cooling gas outlet port, said slag particles inlet port and said slag particles outlet port being closed during the cooling of slag particles and wherein the heated up cooling gas is used for energy recovery.

Accordingly, the above embodiment, it is proposed to use heat exchangers comprising multiple subunits, which are operated discontinuously. As it is advantageous to obtain a constant hot gas flow at the exit of the heat exchanger in order to guarantee the most efficient use of electric power generation cycles, the multiple heat exchanger subunits are operated alternately in a way that an essentially constant hot gas flow is guaranteed. By this, it is possible to obtain an essentially continuous gas handling which is decoupled from the batch type material handling.

At each moment in time, where one of the heat exchanger subunits is in emptying/filling stage, no cooling gas is flowing through this heat exchanger subunit during emptying/filling.

The same quantity of particles is filled into and extracted from the exchanger. Meanwhile, no material is entering or leaving the other heat exchanger subunits; they can thus be completely sealed off from the environment during cooling.

Preferably, one of the subunits is charged with hot slag particles through the inlet port while cooled slag particles are discharged simultaneously through the slag particle outlet port of the same subunit.

Once the heat exchanger subunit is filled up, the slag particles inlet and the slag particles outlet port are sealed and the subunit is reconnected to the cooling gas stream while another heat exchanger subunit may be disconnected. The cooling gas flow through these heat exchanger subunits does thus not encounter any leakage, therefore preventing dust and energy leaving the system. The heat exchanger subunits thus only need to be depressurized during charging and discharging of the slag.

According to a preferred embodiment, the slag particles are first charged in an insulated pre-chamber before they are charged into one of the heat exchanger subunits. The pre-chamber is preferably insulated, either by refractory lining or material stone box, the low thermal conductivity of slag gives excellent insulation properties.

The slag particles may also be charged in a post-chamber after being discharged from the heat exchanger subunit and after cooling. In other words, the cycle time and the quantity of slag charged may thus be chosen in such a way that the heat transfer inside the heat exchanger subunits may be controlled and kept to be quasi-stationary. The outlet gas temperature fluctuation caused by charging/discharging of the heat exchanger subunits will thus be minimized by choosing according cycle times.

Preferably, the heat exchanger subunits are operated under a pressure from 1.2 bar to 4 bar i.e. the absolute pressure measured at the bottom of the slag layer in the subunit.

The detached slag film is preferably crushed into particles of a granulometry of about 40-80 mm and a bulk density of about 1.5 g/cm³, preferably of a granulometry of about 50-70 mm and a bulk density of about 1.5 g/cm³.

### BRIEF DESCRIPTION OF THE DRAWINGS

Further details and advantages of the present invention will be apparent from the following detailed description of not limiting embodiments with reference to the attached drawing, wherein:

FIG. 1 is a schematic layout of an installation for recuperating heat from slag comprising a rotary-cone vitreous slag manufacturing device;

FIG. 2 is a flow sheet of a preferred cooling method of the slag particles produced by the slag manufacturing device described herein.

### DETAILED DESCRIPTION

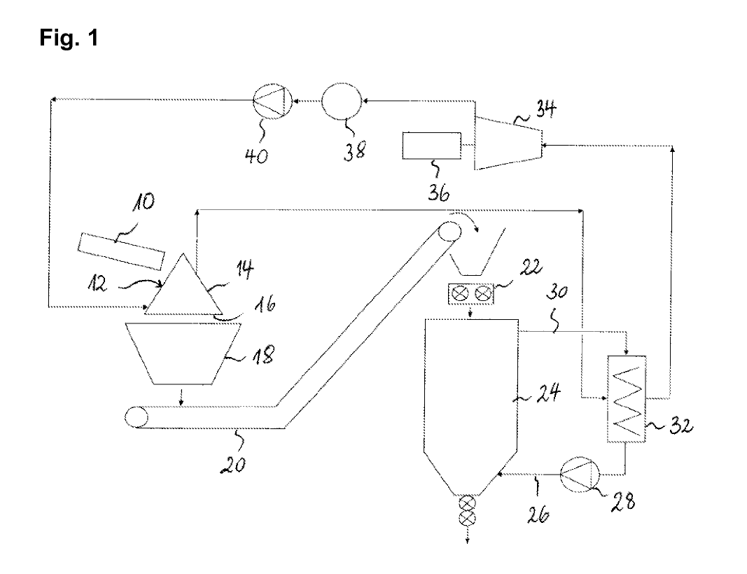

FIG. 1 schematically shows an installation for recuperating heat from slag comprising a rotary-cone vitreous slag manufacturing device according to a preferred embodiment of the present invention. As can be seen on FIG. 1, the liquid slag is poured from a slag runner 10 onto the outer surface 12 of a conical slag cooler 14. The liquid slag is poured onto the outer surface 12 of the cooler in one delimited zone and spreads over the entire length of the surface i.e. from the pouring zone substantially to the base 16 of the cone through the action of gravity. The liquid slag runs along the inclined surface of the slag cooler 14, forms a thin film on the surface of said cone and solidifies as it spreads over the cone. Owing to the rotation of the cone, the slag forms a solidified film substantially along the major part, such as e.g. 70% to 95%, of the outer surface of the cone. During the rotation of the conical slag cooler, the film of slag formed on the surface of the cone rapidly cools down from about 1400-1600° C. to about 800° C. and vitrifies. After about 75% to 95% of a turn, the slag is removed from the shell of the cone and falls into a slag collecting chute 18 situated underneath the conical slag cooler 14 and is then transported via an insulated conveyor 20 into a slag crusher 22, where the vitrified slag is crushed into a small pieces with an approximate size of about 1 to 3 mm (smaller sizes being possible, e.g. if the slag is to be used for cement production).

The crushed slag is then transferred to a slag cooler 24 to be cooled down to between about 100 to about 300° C., is evacuated from the slag cooler 24 and is stored for further use.

To cool the slag in the slag cooler 24, cool air 26 is injected via a fan 28 at the bottom of the slag cooler 24, cool air 26 is gradually heated at the contact of the hot slag and is withdrawn at the top of the slag cooler. The heated air 30 is then transferred to a heat exchanger (boiler) 32 to heat water and to generate steam. Instead of water, another heat transfer medium may be used. The steam generated in the boiler 32 is used to drive a steam turbine 34 and a generator 36 to generate electricity. Other methods such as an Organic Rankine Cycle system can be used to generate electricity. The heated air 30 could also be used in other process applications.

After the steam turbine 34, the cooled steam, or other heat transfer medium, is fed to a condenser 38 and a pump 40 transfers the water or other heat transfer medium from the condenser 38 to the conical slag cooler 14 where it is used to cool the outer surface 12 in contact with the hot slag. The hot water or other heat transfer medium is then pumped back to the boiler 32 for the recuperation of heat.

The conical slag cooler 14 can further comprise a housing (not shown) surrounding the conical slag cooler 14 for recuperating the heat of the slag dissipated by radiation or by forced air convention.

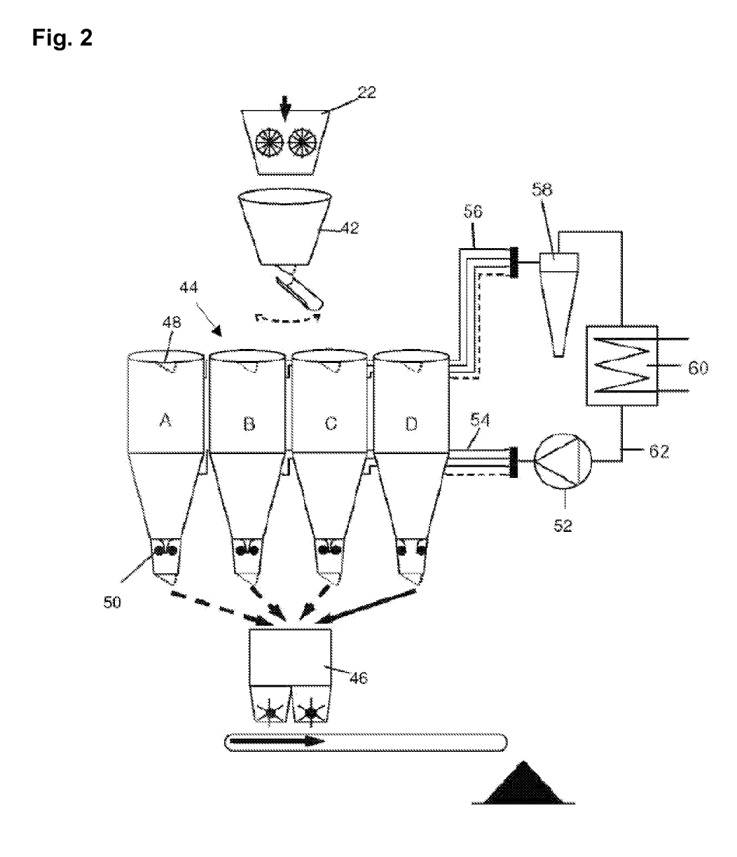

FIG. 2 shows a schematic view of a preferred cooling method of the hot slag particles after dry granulation of hot liquid material.

The crushed slag particles are transferred from the slag crusher 22 to a pre-chamber 42 and then to a slag cooler/heat exchanger 44 comprising in the embodiment depicted on FIG. 2, four heat exchanger subunits A, B, C, D which operate in a counter current mode, i.e. the hot material is fed from the top and withdrawn from the bottom after it has been cooled, whereas the cooling gas, usually air, is injected through the bottom and withdrawn from the top after it has been heated up. During the passage of the air through the heat exchanger, the air is heated up and the slag contained in the heat exchanger is cooled to about 100° C. and is discharged in a post-chamber 46. The cooled slag is stored for further use.

In the embodiment as depicted on FIG. 2, a heat exchanger with four subunits A, B, C, D is used.

From the pre-chamber 42, the pieces of solidified slag are distributed to four different heat exchangers subunits A,B,C,D, equipped with a material gate 48 at the top and a sealing flap 50 at the bottom.

While one of these subunits of the heat exchanger is in emptying/filling stage (cf. FIG. 2; heat exchanger subunit D, the three remaining subunits are in the cooling mode. (cf. FIG. 2: A-B-C in operation).

Once the heat exchanger subunit D is filled up, the material gate 48 at the top and the sealing flap 50 at the bottom are closed and the cooling gas stream through heat exchanger subunit D is activated. The next heat exchanger subunit in the sequence is then disconnected from the gas circuit and the cooled slag particles are evacuated and new hot slag particles are transferred into the subunit.

The described sequential operation of the heat exchanger subunits allows to completely seal off the heat exchanger 44 from the atmosphere during the heat exchange phase, without any losses of gas or dust to the environment. Each heat exchanger subunit is depressurized and isolated from the gas flow only during the charging and discharging of slag particles in order to allow the operation without any negative impact on the heat transfer and on the environment.

The cycle time and the amount of slag particles charged in one cycle is selected in such a way that from the perspective of the heat transfer it can be regarded as a quasi-stationary operation with very low temperature fluctuation in the gas stream. The term cycle time is used herein to describe the time frame during which each heat exchanger subunit is connected or disconnected from the continuous gas flow. During cooling, the slag inside the exchanger will have a temperature gradient from cold at the outlet gate to hot at the slag inlet gate. The amount of slag charged and discharged during one cycle should thus be limited so that the temperature difference between the slag outlet before and after charging/discharging does not exceed, for instance 50° C.

The heat exchanger subunits A,B,C,D are specifically designed and suitable to operate under elevated pressure, which reduces pressure loss of the gas stream considerably and as such the necessary blower/compressor power to circulate the gas through the heat exchanger and steam generator. In this configuration, only the gas losses which occur during the depressurizing of one subunit have to be compensated by a booster blower/compressor (not shown) which serves at the same time as the pressure controller. It is estimated that augmenting the pressure inside the exchanger from 1 bar to 3 bar (absolute), the necessary blower/compressor power drops to approximately ⅓.

The gas stream created by the fan 52 is led to the three heat exchanger subunits in the cooling mode through a gas duct 54. After the heat exchange took place, the heated up gas streams are led out through a hot gas duct 56. The dust is filtered out in a cyclone 58 before the hot gas at about 700° C. is transferred to a heat exchanger for steam creation 60. The steam thus generated is transferred to a turbine (not shown) and a generator (not shown) to produce electricity. The cooled gas is then led back via a pipe 62 in a closed loop system to the fan 52.

At this temperature level of about 700° C., thermodynamic cycle processes for power generation operate at best efficiency. Furthermore, this temperature level offers best flexibility and efficiency for direct heat recovery.

Since the slag-gas heat exchanger 44 runs continuously, efficient electricity generation is possible. In the present embodiment, both the material and gas streams enter and leave the heat exchanger continuously. The material and gas handling are however decoupled: gas leakage is no longer an issue as the concerned heat exchanger subunit is decoupled from the gas flow during charging and discharging. Accordingly, sealing of the heat exchanger subunits can easily be obtained with sealing flaps as no material is in movement inside the exchanger during the gas flow.

The advantages arising from this concept are numerous

Due to the decoupling of the gas and material flows, the sealing of the heat exchanger is simplified and dust emissions into the environment are eliminated respectively minimized. The sealing of the heat exchanger subunits during the cooling operation eliminates the risk of gas leakage and thus the effect of “sand blasting” caused by slag particles entrained by the escaping gas is no longer an issue. This results in lower wear and increased overall operating stability and availability.

The separation of cooling and charging/discharging the heat exchanger subunits allows to operate the cooling phase under a pressurized gas circuit, which reduces the pressure drop over the slag layer and energy consumption of the fan.

As the total slag mass is distributed to several heat exchanger subunits instead of one, the individual subunits have a smaller cross-section. The reduced diameter of the heat exchanger subunits allows easier distribution of the counter current gas flow over the whole cross section. Furthermore, as seen above, the quantity of leaking gas can be significantly lowered. This combined effect leads to better overall efficiency since the required fan power is lower. The overall thermal efficiency of the slag granulation is increased due to reduced losses of hot air.

No constantly rotating parts are needed in this concept, indeed no rotary valves are needed to discharge the heat exchangers, only a pinch/slider/squeeze valve is needed. This results in lower wear.

This concept allows continuous operation even if one of the heat exchanger subunits exchangers is out of order, although at a decreased overall slag flow rate.

This allows easy maintenance on one of these exchanger sub units. Furthermore, unforeseen failures on one of the exchanger sub units do not create the need of shutting down the whole process.

1. A process for manufacturing a vitreous slag, comprising:
rotating a cone about a vertical cone axis, said cone comprising an external shell having a lateral surface;
cooling the lateral surface of said external shell;
pouring molten slag on said lateral surface of said cone to form a film of slag by gravity which is solidified as it is entrained in rotation by said cone about said cone axis; and
detaching pieces of said film from said lateral surface and removing solidified slag in the form of said pieces after said film has been entrained through between 0.6 and 0.9 revolutions of said cone,
said molten slag being poured onto said lateral surface in a pouring zone and forming a film over between 75% and 95% of the length of said lateral surface.

2. The process for manufacturing a vitreous slag according to claim 1, wherein the cone comprises an angle between the lateral surface and a base of the cone, said angle being comprised between 10 and 35 degrees.

3. The process according to claim 1, wherein the cone is rotated at a speed between about 0.5 to 5 rpm.

4. The process according to claim 1, wherein the cone has a length of about 1 to 10 m, measured from the base to the pouring zone.

5. The process according to claim 1, wherein the base of the cone is from about 2 to 30 m in diameter.

6. The process according to claim 1, wherein heat recuperated during the cooling of the external shell of the cone is used to generate steam and/or electricity.

7. The process according to claim 1, wherein the detached pieces of said film are crushed and then cooled to from about 100° C. to about 300° C. and wherein heat recuperated during the cooling of the detached pieces of said film is used to generate steam and/or electricity.

8. The process according to claim 1, wherein the detached pieces of said film are crushed to form slag particles which are charged in a heat exchanger, cooled with a countercurrent flow of cooling gas and discharged from the heat exchanger wherein the heat exchanger is subdivided in a plurality of subunits, each of said subunits having a slag particles inlet port, a slag particles outlet port, a cooling gas inlet port and a cooling gas outlet port, wherein at least one of the subunits is charged with hot slag particles through the inlet port, cooled slag particles are discharged through said slag particles outlet port from said at least one of the subunits, said cooling gas inlet port and said cooling gas outlet port being closed during the charging and discharging of slag particles and wherein, simultaneously to the charging and discharging of slag particles, at least one of the other subunits is cooled by injecting a flow of cooling gas through the cooling gas inlet port and withdrawing a flow of heated cooling gas from said cooling gas outlet port, said slag particles inlet port and said slag particles outlet port being closed during the cooling of slag particles and wherein the heated up cooling gas is used for energy recovery.

9. A device for manufacturing a vitreous slag, which comprises:
a cone having a vertical cone axis, a base and a shell,
said shell having a lateral surface comprising a first and a second side, said second side being opposite of said first side;
a drive for rotating said cone, said drive being adapted to rotate said cone around its cone axis;
a slag feeder, arranged in proximity of the shell for pouring a molten slag in a pouring zone onto said first side of said shell;
a detaching device to remove the slag film from the shell;
a cooling device for cooling said shell,
wherein said device is configured to convert molten slag deposited onto said shell into a vitreous slag film.

10. The device according to claim 9, wherein the cone comprises an angle between the lateral surface and a base of the cone, said angle is comprised between 10 and 35 degrees.

11. The device according to claim 9, further comprising a slag crusher.

12. The device according to claim 9, wherein the cone has a length of about 1 to 10 m, measured from the pouring zone to the base of said cone.

13. The device according to claim 9, wherein the base of the cone is from about 2 to 30 m in diameter.

14. The device according to claim 9, further comprising a controller to adjust the rotational speed of the cone from 0.5 to 5 rpm.
